(19) United States
(12) Patent Application Publication
(10) Pub. No.: US 2009/0053374 A1
(43) Pub. Date: Feb. 26, 2009

(54) Beverage Container

(76) Inventor: Clifford J. Finn, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 11/842,228

(22) Filed: Aug. 21, 2007

(51) Int. Cl. A23L 2/56; A47J 31/40

(52) U.S. Cl. 426/425; 99/296

(57) ABSTRACT

A beverage container including a base defining a primary volume for holding the beverage. A neck having an open top extends from the base and defines a passageway in fluid communication with the primary volume and the open top. A secondary volume defined by the neck intersects the passageway for holding a beverage flavoring disposed in the passageway for flavoring the beverage flowing from the primary volume through the passageway.

### CROSS REFERENCES TO RELATED APPLICATIONS

Not Applicable.

### STATEMENT REGARDING FEDERALLY SPONSORED RESEARCH

Not Applicable.

### TECHNICAL FIELD

This invention relates to a beverage container, and in particular to a beverage container having a neck extending between a primary volume and an opening in fluid communication with the primary volume.

### DESCRIPTION OF THE BACKGROUND ART

Beverage containers, such as beer bottles, soft drink bottles, and the like, typically have a base defining a primary volume for holding a beverage. A tubular neck extending from the base has an open top through which the primary volume is emptied of the beverage. Some beverage consumers enjoy flavoring their beverage with a fruit slice, such a lemon slice, lime slice, and the like. This extra flavoring can be accomplished in multiple ways. For example, the beverage can be poured out of the beverage container into a glass containing the fruit slice. Alternatively, when pouring the beverage into a separate glass is not desired, the fruit slice can be introduced into the beverage container.

When pouring the beverage into a separate glass is not desired, the fruit slice is often stuffed through the open top of the beverage into the tubular neck. This method results in a crumpled unsightly fruit slice getting lodged in the neck where it can unexpectedly flow into a consumer's mouth as the consumer takes drink. Alternatively, the fruit slice falls through the tubular neck into the primary volume and unceremoniously sinks to the bottom of the primary volume of the beverage container. The fruit slice at the bottom of the primary volume flavors the beverage near the bottom of the primary volume while leaving the beverage near the top of the primary volume relatively unflavored by the fruit slice. As a result, the consumer receives overly fruit flavored beverage as the beverage container is emptied which is preceded by relatively little fruit flavoring when the consumer begin consuming the beverage.

A need exists for a beverage container that retains a beverage flavoring, such as a fruit slice, in the neck above the primary volume in order to continuously flavor the beverage as the beverage flows through the neck of the beverage container. A further need exists to display the beverage flavoring in the beverage container in a pleasing manner that enhances the beverage consumption experience.

### SUMMARY OF THE INVENTION

The present invention provides a beverage container and method of use that securely holds a beverage flavoring to continuously flavor the beverage as the beverage flows through the neck of the beverage container. Advantageously, the beverage container can also be adapted to pleasingly display the beverage flavoring disposed therein. The beverage container includes a base defining a primary volume for holding the beverage. A neck having an open top extends from the base and defines a passageway in fluid communication with the primary volume and the open top. A secondary volume defined by the neck intersects the passageway for holding a beverage flavoring disposed in the passageway for flavoring the beverage flowing from the primary volume through the passageway.

A general objective of the present invention is to securely hold a beverage flavoring to continuously flavor the beverage as the beverage flows through the neck of the beverage container. This objective is accomplished by providing the secondary volume defined by the neck which intersects the passageway for holding the beverage flavoring disposed in the passageway for flavoring the beverage flowing from the primary volume through the passageway.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a perspective view of a beverage container incorporating the present invention;

FIG. 2 is a front view in elevation of the beverage container of FIG. 1;

FIG. 3 is a side view in elevation of the beverage container of FIG. 2;

FIG. 4 is a sectional partial view in vertical section taken in the plane of the line 4-4 of FIG. 1;

FIG. 5 is a the view of FIG. 4 with a fruit slice being inserted into the neck top;

FIG. 6 is the view of FIG. 4 with the fruit slice received in the secondary volume;

FIG. 7 is a cross sectional view along line 7-7 of FIG. 6; and

FIG. 8 is an alternative embodiment of a beverage containing incorporating the present invention.

### DETAILED DESCRIPTION OF THE PREFERRED EMBODIMENTS

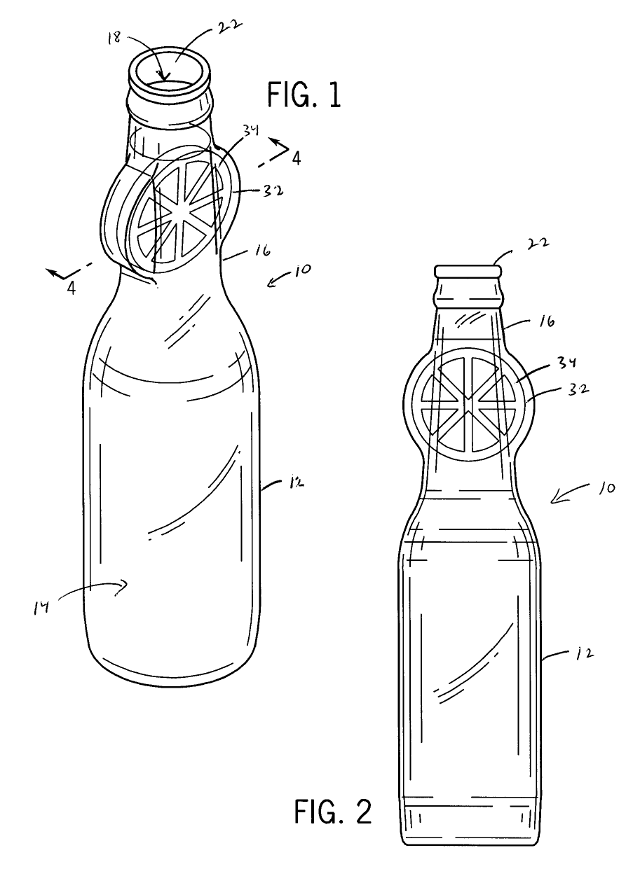

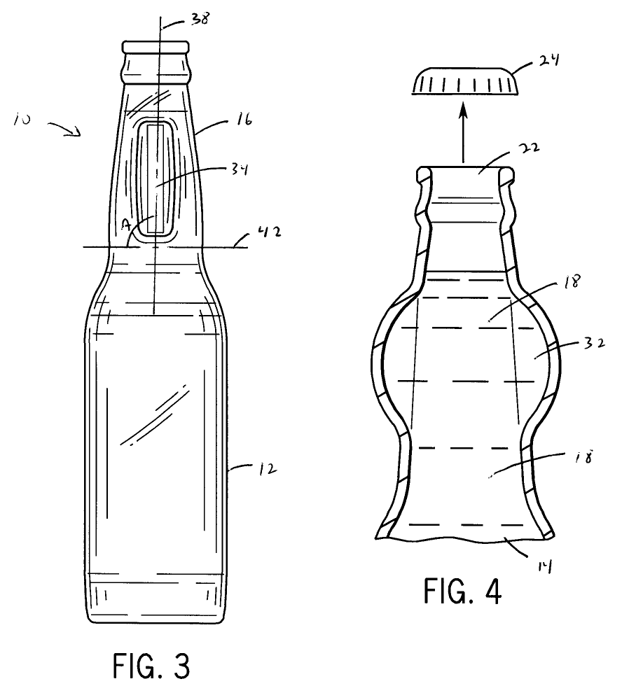

As shown in FIGS. 1-4, a beverage container 10 incorporating the present invention includes a body 12 defining a primary volume 14 for holding a beverage. The beverage can be any consumable liquid, such as beer, soft drink, water, juice, and the like. A tubular neck 16 extending from the body 12 defines a passageway 18 through which the beverage is discharged from the primary volume 14. the passageway 18 is in fluid communication with the primary volume 14 and terminates at an open top 22. A cap 24 (shown in FIG. 3) seals the open top 22 after the primary volume 14 is filled with the beverage and prior to consumption of the beverage.

A secondary volume 32 defined by the neck 16 intersects the passageway 18 for holding a beverage flavoring 34, such as a fruit slice shown in FIGS. 1-7. Although a beverage flavoring 34 in the form of a fruit slice, such as a lemon slice or lime slice is preferred, slices of other fruits, such as apples, pears, can be used. Moreover, other beverage flavoring 34, such as a spice pack, berries, mints, and the like, can be used without departing from the cope of the invention. In a preferred embodiment, the beverage flavoring 34 expands or unfolds into the secondary volume 32 to anchor the beverage flavoring 34 in the secondary volume 32.

The secondary volume 32 intersects the passageway 18 to bathe the beverage flavoring 34 in the beverage as the beverage flows from the primary volume 14 through the passageway 18. Advantageously, the bathed beverage flavoring flavors the beverage with the beverage flavoring 34 just prior to consumption of the beverage while being securely held in the beverage container 10. The secondary volume 32 can have any shape that securely holds the beverage flavoring 34 therein. Preferably, the secondary volume 32 has a disc shape for holding a disc-shaped fruit slice. However, a partial disc shape, wedge shape, spherical shape, and the like, adapted to securely hold other shaped beverage flavorings can be provided without departing from the scope of the invention.

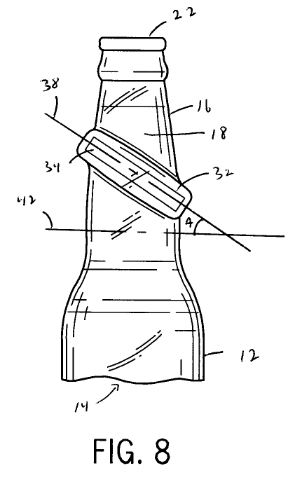

Advantageously, the secondary volume 32 having a non-spherical shape can be oriented to pleasingly display the beverage flavoring 34 disposed in the beverage container 10. Preferably, the secondary volume 32 defines a secondary volume plane 38 in which the beverage flavoring 34 is held, and the secondary volume plane 38 defines a non-zero angle A with a passageway plane 42 perpendicular to a direction of beverage flow through the passageway 18 to display the beverage flavoring 34 in the secondary volume 32. In the embodiment shown in FIGS. 1-7, the non-zero angle A is approximately 90°. In another embodiment shown in FIG. 8, the non-zero angle A is approximately 45°. Although two preferred non-zero angles are disclosed, the secondary volume plane 38 can define any non-zero angle with the passageway plane 42 without departing from the scope of the invention.

Preferably, the beverage container 10 is formed from a transparent or opaque plastic or glass suitable for containing a consumable food item. The beverage container 10 can be fabricated using any suitable container manufacturing methods known in the art, such as blow molding.

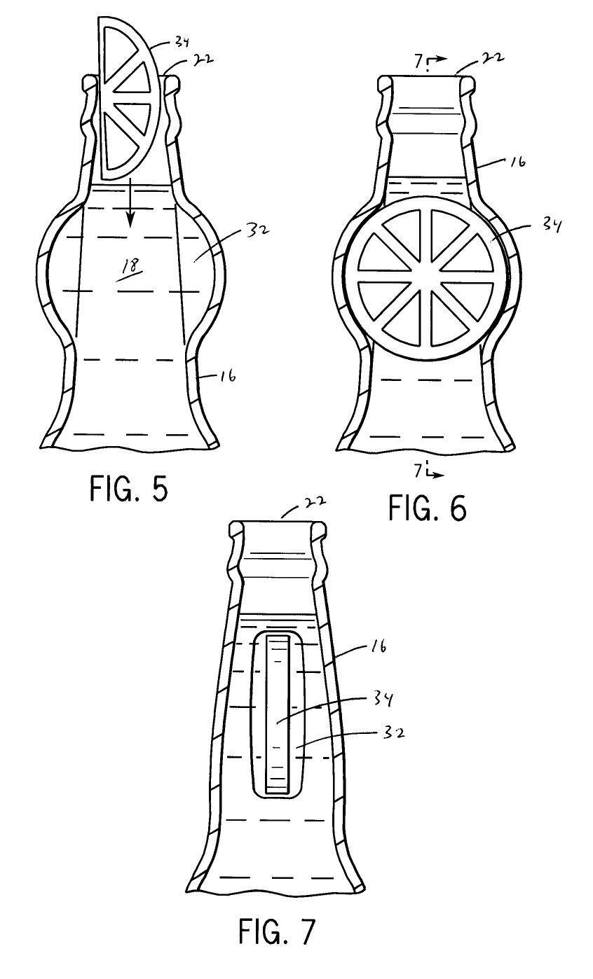

In use of a preferred embodiment, as shown in FIGS. 4-7, a consumer removes the cap 24 from the open top 22 of the neck 16 and deforms, such as by folding, the beverage flavoring 34, such as a foldable fruit slice, to fit through the open top 22 of the neck 16. As shown in FIG. 5, the deformed beverage flavoring 34 is slipped through the open top 22 into the passageway 18 until the beverage flavoring 34 is received in the secondary volume 32. Preferably, the beverage flavoring 34 expands, such as by unfolding, in the secondary volume 32 to pleasingly display and secure the beverage flavoring 34 in the beverage container 10. Advantageously, when the consumer pours the beverage through the passageway 18 and out the open top 22, the beverage flavoring 34 is bathed by the beverage to flavor the beverage with the beverage flavoring 34 just prior to consumption while securely holding the beverage flavoring 34 in the beverage container 10.

While there has been shown and described what is at present considered the preferred embodiment of the invention, it will be obvious to those skilled in the art that various changes and modifications can be made therein without departing from the scope of the invention defined by the appended claims.

I claim:

1. A beverage container comprising:
a base defining a primary volume for holding a beverage;
a neck extending from said base and having an open top, said neck defining a passageway in fluid communication with said primary volume and said open top; and
a secondary volume defined by said neck and intersecting said passageway for holding a beverage flavoring disposed in said passageway for flavoring the beverage flowing from the primary volume through said passageway.

2. The beverage container as in claim 1, in which said secondary volume defines a plane in which the beverage flavoring is held, and said plane defines a non-zero angle with a plane perpendicular to a direction of beverage flow through said passageway to display said beverage flavoring in said secondary volume.

3. The beverage container as in claim 1, in which said secondary volume is a disk shape.

4. The beverage container as in claim 1, in which said beverage flavoring is a fruit slice, and said secondary volume has a shape adapted for receiving said fruit slice.

5. A method of flavoring a beverage in a beverage container including a base defining a primary volume for holding a beverage, a neck extending from said base and having an open top, said neck defining a passageway in fluid communication with said primary volume and said open top, and a secondary volume defined by said neck and intersecting said passageway for holding a beverage flavoring disposed in said passageway for flavoring the beverage flowing from the primary volume through said passageway, said method comprising:
inserting a beverage flavoring through the open top of the neck and into the secondary volume;
bathing said beverage flavoring in the secondary volume with a beverage disposed in the primary volume as the beverage passes through the passageway.

6. The method as in claim 5, in which said secondary volume defines a plane in which the beverage flavoring is held, and said plane defines a non-zero angle with a plane perpendicular to a direction of beverage flow through said passageway, and said method includes displaying said beverage flavoring in said secondary volume.

7. The method as in claim 5, in which said beverage flavoring is a fruit slice.

8. The method as in claim 5, including allowing said beverage flavoring to expand in said secondary volume.

9. A beverage container comprising:
a base defining a primary volume for holding a beverage;
a neck extending from said base and having an open top, said neck defining a passageway in fluid communication with said primary volume and said open top;
a secondary volume defined by said neck and intersecting said passageway for holding a portion of fruit disposed in said passageway for flavoring the beverage flowing from the primary volume through said passageway; and
a portion of fruit disposed in said secondary volume.

10. The beverage container as in claim 9, in which said secondary volume defines a plane in which the portion of fruit is held, and said plane defines a non-zero angle with a plane perpendicular to a direction of beverage flow through said passageway to display said portion of fruit in said secondary volume.

11. The beverage container as in claim 9, in which said secondary volume is a disk shape.

12. The beverage container as in claim 9, in which said secondary volume has a shape conforming to said portion of fruit.
